(19) United States
(12) Patent Application Publication
(10) Pub. No.: US 2005/0132095 A1
(43) Pub. Date: Jun. 16, 2005

(54) Method and apparatus for controlling peripheral devices in a computer system

(76) Inventor: David L. Collins, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/731,959

(22) Filed: Dec. 10, 2003

(51) Int. Cl. G06F 3/00

(52) U.S. Cl. 710/15

(57) ABSTRACT

The disclosed embodiments relate to a system for controlling peripheral devices in a computer system. The system for controlling peripheral devices may comprise a microcontroller that provides a plurality of device interfaces, each of the device interfaces being adapted to support a peripheral device, and a communication interface that is adapted to allow communication between the communication interface and the peripheral devices, and a device that stores programming instructions to initialize the microcontroller separately from the initialization of the computer system.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing the gigahertz range (one billion operations per second) and continuing well beyond. This increase in speed has necessitated many changes in the architecture of computer systems to make them process information more efficiently.

In many computer systems, the system microprocessor is assisted by integrated circuit devices that perform supporting functions. For example, many computer systems include a memory controller, which manages communications between the microprocessor and system memory. The memory controller may be referred to as a “north bridge” or as “core logic.” The use of a memory controller may free up the microprocessor to perform other functions.

Another support function that may be provided to the microprocessor is the management of communications with peripheral devices such as disk drives, printers, network interfaces and the like. The device that performs the function of providing an interface between a microprocessor and peripheral devices may be referred to as a peripheral device controller or “south bridge.”

South bridges are manufactured by a large number of companies, and each company may design south bridges to operate according to their own proprietary protocols. One aspect of the operating protocol for south bridges is the programming interface. The programming interface comprises register definitions and locations that store control information for the south bridge. The information stored in these registers determines which features of the south bridge are enabled or disabled, and/or how those features operate. Because south bridges operate according to a wide range of programming models, it may be difficult for manufacturers of computer systems to effectively design south bridges into their computer systems.

Another disadvantage of south bridge devices is that many functions performed by a particular south bridge may also be performed by other devices within the computer system. This is particularly true in the area of power management. This duplication of effort may result in incompatibilities in the system, which may adversely affect system performance. Additionally, computing overhead may be expended to disable functions within the south bridge to prevent these incompatibilities. Even if functions performed by the south bridge are disabled, computing resources such as memory space, input/output (I/O) addresses and the like may be used by the south bridge to keep problems from occurring. Those resources would not be available for productive use by other devices within the computer system.

### BRIEF DESCRIPTION OF THE DRAWINGS

Advantages of one or more disclosed embodiments may become apparent upon reading the following detailed description and upon reference to the drawings in which:

FIG. 1 is a block diagram of a computer system in which embodiments of the present invention may be employed; and

FIG. 2 is a block diagram illustrating the use of a peripheral device controller in a computer system in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

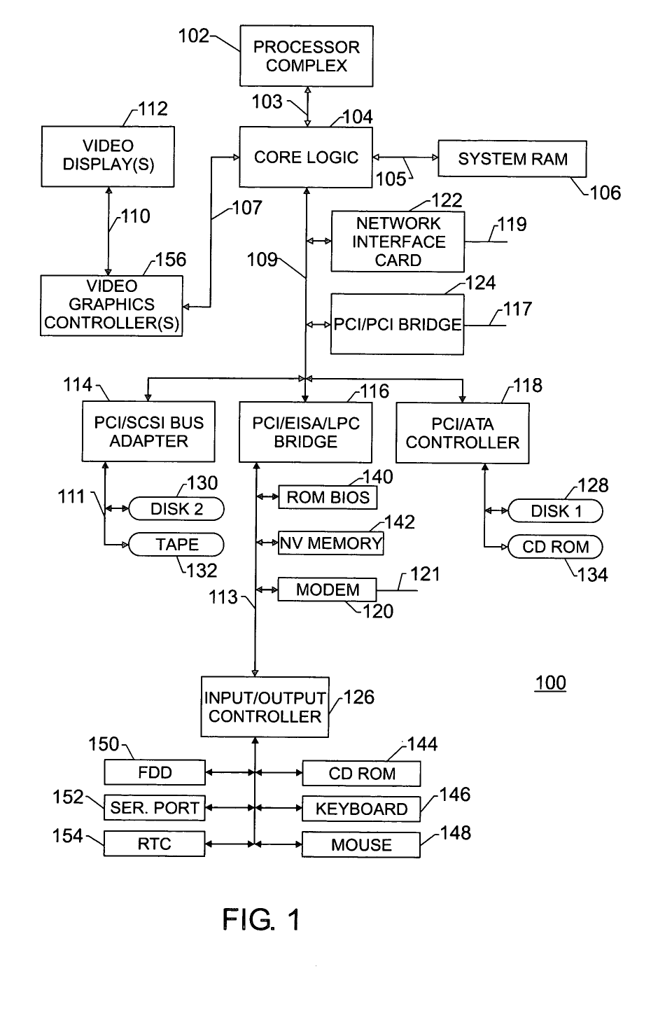

FIG. 1 is a block diagram of a computer system in which embodiments of the present invention may be employed. The computer system is generally indicated by the numeral 100. A processor complex 102 may comprise one or more central processing units (“CPUs”). If multiple CPUs are included in the processor complex, the CPUs may be arranged in a symmetric or asymmetric multi-processor configuration. As will be appreciated by one of ordinary skill in the art, single or multilevel cache memory (not illustrated) may also be included in the computer system 100.

Also included in the computer system 100 is a north bridge 104 (“core logic”), which manages communications between the processor complex 102 and a system random access memory (“RAM”) 106, a video graphics controller 156, and a network interface card (“NIC”) 122. The NIC 122 is connected to a local area network 119. The north bridge 104 may be connected to the processor complex 102 via a processor bus 103 and the system RAM via a memory bus 105. The video graphics controller 156, which is connected to the north bridge 104 via an Accelerated Graphics Port (“AGP”) bus 107 or the like, may provide a video signal to a video display 112 via a video interface 110. The north bridge 104 may also be connected to a Peripheral Component Interface/Peripheral Component Interface (“PCI/PCI”) bridge 124 via a primary PCI bus 109, for example, to provide additional PCI buses (117) for the computer system 100. Those of ordinary skill in the art will appreciate that an Extended Peripheral Component Interface (“PCI-X”) bus or an Infiniband bus may be substituted for the primary PCI bus 109. The specific protocol of the bus 109 (or any of the communications interfaces illustrated herein) is not believed to be a crucial aspect of the present invention.

A PCI/SCSI bus adapter 114 and a PCI/ATA controller 118 may also be connected to the north bridge 104 via the PCI bus 109. The PCI/SCSI bus adapter 114 may support a wide array of devices of which a disk drive 130 and/or a tape drive 132 are examples. The PCI/ATA controller 118 may support a wide array of devices of which a disk drive 128 and a CD ROM drive 134 are examples.

The computer system 100 also includes a PCI/EISA/LPC bridge 116, which may be referred to as a peripheral device controller or south bridge. The south bridge 116 provides an interface between the PCI bus 109 and a plurality of peripheral devices. Those peripheral devices may include a ROM BIOS 140, which provides the low-level programming for the computer system 100. A non-volatile memory device (for example, flash memory) 142 and a modem 120 may additionally be supported by the south bridge 116. The modem may be connected to a communication line such as a telephone line 121 or the like.

An input/output controller 126, which may also be referred to as a Super I/O controller, may be connected via an EISA or low pin count (LPC) bus 113 to the south bridge 116 to support additional peripheral devices. A Super I/O controller generally provides I/O support for a group of I/O devices. Examples of devices that may be supported by the Super I/O controller 126 include a keyboard 146, CD-ROM drive 144, mouse 148, floppy disk drive (“FDD”) 150, serial and/or parallel ports 152 and a real time clock (“RTC”) 154. The components shown in FIG. 1 may receive power by a main power supply (not shown) when the computer system 100 is turned on or “powered up.”

The south bridge 116 may comprise a plurality of registers that may be used to store control information that governs its operation. These registers may be accessible by a proprietary programming interface that is designed by the manufacturer of the south bridge 116. When the computer system 100 is powered up, system firmware may program the south bridge control registers as a part of the computer system's power-on self test (“POST”) to enable communication with the peripherals that the south bridge 116 supports. User interfaces and system management features (for example, power management) may also be enabled.

The south bridge 116 may cause incompatibilities in the computer system 100 because the south bridge 116 may be adapted to perform functions that may also be performed by other system components, such as the operating system or the like. For example, the south bridge 116 may be adapted to provide power management for one or more of the peripheral devices that it controls. Unfortunately, the power management provided by the south bridge 116 may interfere with power management functionality provided by the operating system.

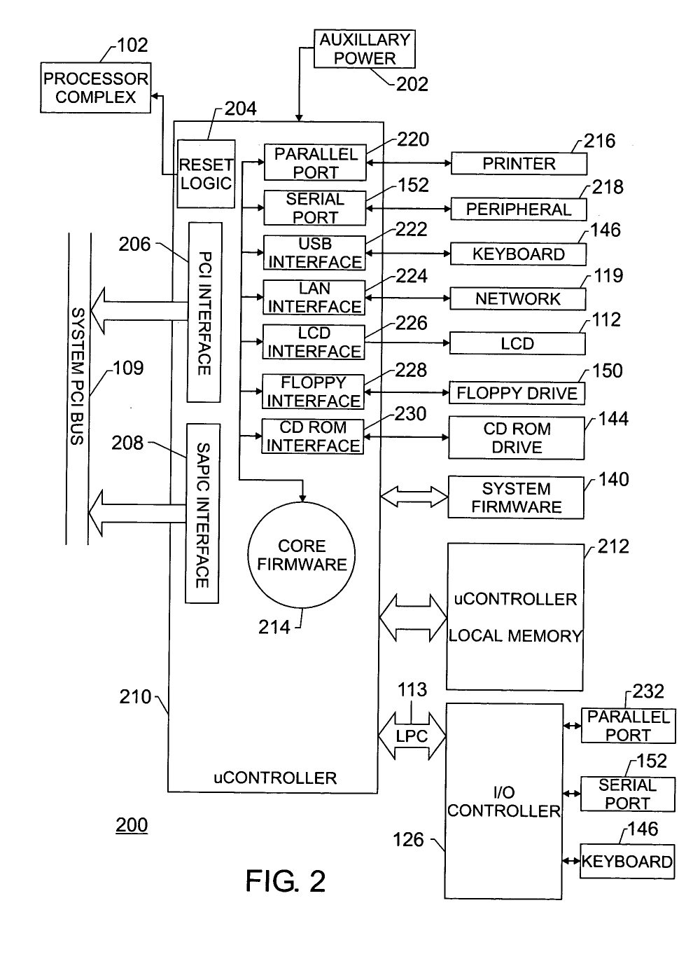

Thus, it may be desirable to disable certain functionality of the south bridge 116 via its programming interface. This means that computer systems designed using the south bridge 116 must implement a communication interface that can communicate with the south bridge 116 via its programming model. This may be difficult and time consuming to do. Additionally, particular functionality associated with the south bridge 116 may consume computing resources such as reserved system memory and/or I/O addresses even though that particular functionality is disabled. The replacement of the south bridge 116 with a standard microcontroller or the like is described below with respect to FIG. 2.

FIG. 2 is a block diagram illustrating the use of a peripheral device controller in a computer system in accordance with embodiments of the present invention. The computer system is generally referred to by the reference numeral 200 and system devices that were identified above with respect to FIG. 1 are given the same reference numeral in FIG. 2. In the computer system 200, the south bridge is replaced by a microcontroller 210. A microcontroller is a general purpose processor similar to a microprocessor that may be programmed to perform a specific task within a system.

The microcontroller 210 may comprise reset logic 204 to reset the processor complex 102 upon initialization of the computer system 200. Additionally, the microcontroller 210 may be powered by an auxiliary power supply 202 (i.e. not the main power supply of the computer system 100). The use of auxiliary power for the microcontroller 210 may allow the microcontroller 210 to be employed to perform system firmware upgrades and system management activities while the computer system 200 is not powered up by the main power supply.

The microcontroller 210 may be connected for communication via a PCI bus such as the primary or compatibility PCI bus 109. In this manner, the microcontroller 210 may be adapted to participate in the PCI discovery process during POST. The microcontroller 210 may be designated as the system subtractive decode PCI agent instead of a traditional south bridge. Those of ordinary skill in the art will appreciate that, according to PCI specifications promulgated by the PCI Special Interest Group, the subtractive decode agent decodes PCI bus cycles that are not claimed by any other device. Although most subtractive cycles result from errors, they are generally addressed so that a system may comply with the PCI specifications.

As set forth below, the microcontroller 210 may provide support for devices that were previously supported by either the south bridge or subordinate devices such as a Super I/O controller. Peripheral devices may be either supported directly by the microcontroller 210 or they may be supported in a legacy-compatible fashion. Examples of both direct support and legacy compatible support are illustrated in FIG. 2. To provide legacy-compatible support, the microcontroller 210 may be adapted to communicate with a Super I/O controller 126 via a bus such as a Low Pin Count (“LPC”) bus 113. The Super I/O controller 126 may in turn support legacy devices such as a parallel port 232, serial ports 152 and a keyboard 146.

For direct support of peripheral devices, the microcontroller 210 may emulate device interfaces typically provided by a traditional south bridge. Examples of such interfaces include a parallel port 220, a plurality of serial ports 152, a Universal Serial Bus (“USB”) interface 222, a network or local area network (“LAN”) interface 224, a liquid crystal display (“LCD”) interface 226, a floppy disk drive interface 228, a CD ROM interface 230 or the like. These interfaces may provide support for a plurality of peripheral devices, which may include a printer 216, a miscellaneous serial peripheral 218, a key board 146, a network 119, an LCD display device 112, a floppy disk drive 150, a CD ROM drive 144 and the like.

Access to system firmware or ROM BIOS 140 may be provided via the microcontroller 210. Additionally, the microcontroller 210 may have access to a local memory 212, which may be distinct from the system RAM 106 (FIG. 1). The microcontroller 210 may have access to a storage device that stores core firmware 214. The core firmware 214 comprises programming instructions that initialize the microcontroller and prepare it for operation separately from the computer system 200. For example, the core firmware 214 may be adapted to operate the reset logic 204, initialize device interfaces such as the PCI interface 206 and the SAPIC interface 208, begin device emulations for the parallel port 220, the serial port 152, the USB interface 222, the LAN interface 224, the LCD interface 226, the floppy interface 228, the CD ROM interface 230 or the like. The programming instructions that comprise the core firmware 214 may be implemented in hardware, software or some combination thereof. The use of the core firmware 214 to initialize the microcontroller 210 may allow the size of the system ROM BIOS or firmware 140 to be reduced because initialization code for the south bridge (which has been replaced by the microcontroller 210) is no longer needed. This reduction in size of the system firmware 140 may also reduce the time required by the system POST.

The primary PCI bus 109 may provide access to the various component interfaces supported by the microcontroller 210 via a PCI interface 206. A PCI-X interface or any other suitable interface may be substituted for the PCI interface 206 as a matter of design choice. In addition, the PCI bus 109 may provide access to interrupt controller functionality, which may be implemented on the microcontroller 210 in the form of a Streamlined Advanced Programmable Interrupt Controller (“SAPIC”) interface 208.

The microcontroller 210 may be adapted to provide proprietary system management functionality. This capability may allow the elimination of additional system management controller hardware from the computer system 200. Additionally, the microcontroller 210 may communicate with the operating system of the computer system 200 using Advanced Configuration and Power Interface (“ACPI”) descriptors.

The replacement of a traditional system south bridge with a microcontroller such as the microcontroller 210 may result in several advantages. The microcontroller may be designed into a wide range of computer systems, which allows a consistent view of traditional south bridge functionality to the system firmware and operating system software across product lines. The microcontroller may be designed to avoid conflicts with functions provided by other devices and to conserve system resources that would be consumed by a traditional south bridge.

Additionally, the microcontroller may allow field upgradeability by supporting remote programmability. The use of a microcontroller instead of a traditional south bridge may reduce system complexity and improve cost effectiveness by reducing computer system part count and printed circuit board real estate compared to a typical computer system. Traditional south bridge functionality may be combined with other functionality, such as system management functionality, into a single integrated circuit device.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for controlling peripheral devices in a computer system, the system for controlling peripheral devices comprising:
a microcontroller that provides a plurality of device interfaces, each of the device interfaces being adapted to support a peripheral device, and a communication interface that is adapted to allow communication between the communication interface and the peripheral devices; and
a device that stores programming instructions to initialize the microcontroller separately from the initialization of the computer system.

2. The system set forth in claim 1, comprising an auxiliary power source that supplies power to the microcontroller separately from a main power supply that supplies power to the system.

3. The system set forth in claim 1, wherein the communication interface comprises a Peripheral Component Interface (“PCI”) interface.

4. The system set forth in claim 1, wherein the communication interface comprises an Extended Peripheral Component Interface (“PCI-X”) interface.

5. The system set forth in claim 1, wherein the microcontroller comprises a Streamlined Advanced Programmable Interrupt Controller (“SAPIC”) interface.

6. The system set forth in claim 1, wherein the microcontroller is adapted to provide power management functionality for at least one of the peripheral devices.

7. The system set forth in claim 1, wherein at least one of the peripheral devices is a Super I/O controller.

8. The system set forth in claim 1, wherein the microcontroller is defined to be a subtractive decode agent for the computer system.

9. The system set forth in claim 1, comprising reset logic that resets the system under control of the microcontroller.

10. The system set forth in claim 1, wherein the microcontroller provides emulation for at least one of the peripheral devices.

11. The system set forth in claim 1, comprising a local memory associated with the microcontroller.

12. A computer system, comprising:
a main power supply that provides power to the computer system;
a processor complex;
a system memory;
a memory controller that is connected to the processor complex and the system memory to retrieve data from the system memory for the processor complex;
a microcontroller that is connected to the memory controller, the microcontroller providing a plurality of device interfaces, each of the device interfaces being adapted to support a peripheral device, and a communication interface that is adapted to allow communication with the peripheral devices via the plurality of device interfaces; and
a device that stores programming instructions to initialize the microcontroller separately from the initialization of the computer system.

13. The computer system set forth in claim 12, comprising an auxiliary power source to supply power to the microcontroller.

14. The computer system set forth in claim 12, wherein the communication interface comprises a Peripheral Component Interface (“PCI”) interface.

15. The computer system set forth in claim 12, wherein the communication interface comprises an Extended Peripheral Component Interface (“PCI-X”) interface.

16. The computer system set forth in claim 12, wherein the microcontroller comprises a Streamlined Advanced Programmable Interrupt Controller (“SAPIC”) interface.

17. The computer system set forth in claim 12, wherein the microcontroller is adapted to provide power management functionality for at least one of the peripheral devices.

18. The computer system set forth in claim 12, wherein at least one of the peripheral devices is a Super I/O controller.

19. The computer system set forth in claim 12, wherein the microcontroller is defined to be a subtractive decode agent for the computer system.

20. The computer system set forth in claim 12, comprising reset logic that resets the system under control of the microcontroller.

21. The computer system set forth in claim 12, wherein the microcontroller provides emulation for at least one of the peripheral devices.

22. The computer system set forth in claim 12, comprising a local memory associated with the microcontroller.

23. A method of controlling peripheral devices in a computer system, the method comprising the acts of:
initializing a microcontroller that includes a plurality of device interfaces, each of the device interfaces being adapted to support a peripheral device, the microcontroller comprising a communication interface that is adapted to allow communication between the communication interface and the peripheral devices; and
programming the microcontroller separately from the computer system.

24. The method set forth in claim 23, comprising the act of providing auxiliary power to the microcontroller.

25. The method set forth in claim 23, comprising the act of defining a Streamlined Advanced Programmable Interrupt Controller (“SAPIC”) interface for the microcontroller.

26. The method set forth in claim 23, comprising the act of employing the microcontroller to provide power management functionality for at least one of the peripheral devices.

27. The method set forth in claim 23, comprising the act of employing the microcontroller to communicate with a Super I/O controller via at least one of the device interfaces.

28. The method set forth in claim 23, comprising the act of defining the microcontroller to be a subtractive decode agent for the computer system.

29. The method set forth in claim 23, comprising resetting the system under control of the microcontroller.

30. The method set forth in claim 23, comprising emulating at least one of the peripheral devices.

31. A system for controlling peripheral devices in a computer system, the system for controlling peripheral devices comprising:
means for interfacing with a plurality of peripheral devices via a communication interface; and
a device that stores programming instructions to initialize the means for interfacing separately from the initialization of the computer system.

32. The system set forth in claim 31, comprising an auxiliary power source that supplies power to the means for interfacing.

33. The system set forth in claim 31, wherein the communication interface comprises a Peripheral Component Interface (“PCI”) interface.

34. The system set forth in claim 31, wherein the communication interface comprises an Extended Peripheral Component Interface (“PCI-X”) interface.

35. The system set forth in claim 31, wherein the means for interfacing comprises a Streamlined Advanced Programmable Interrupt Controller (“SAPIC”) interface.

36. The system set forth in claim 31, wherein the means for interfacing provides power management functionality for at least one of the peripheral devices.

37. The system set forth in claim 31, wherein at least one of the peripheral devices is a Super I/O controller.

38. The system set forth in claim 31, wherein the means for interfacing is defined to be a subtractive decode agent for the computer system.

39. The system set forth in claim 31, comprising reset logic that resets the system under control of the means for interfacing with a plurality of peripheral devices.

40. The system set forth in claim 31, wherein the means for interfacing with a plurality of peripheral devices provides emulation for at least one of the peripheral devices.

41. The system set forth in claim 31, comprising a local memory associated with the means for interfacing with a plurality of peripheral devices.

42. A computer system that comprises a microcontroller that functions as a south bridge, the microcontroller being programmed to avoid conflicts with other devices and to reduce resource consumption.
